(19) United States
(12) Patent Application Publication
(10) Pub. No.: US 2008/0024481 A1
(43) Pub. Date: Jan. 31, 2008

(54) REFRESH CIRCUIT, DISPLAY DEVICE INCLUDING THE SAME AND METHOD OF REFRESHING PIXEL VOLTAGE

(76) Inventors: Jae-Goo Lee, Yongin-si (KR); Im-Soo Kang, Yongin-si (KR)

Correspondence Address: F. CHAU & ASSOCIATES, LLC, 130 WOODBURY ROAD, WOODBURY, NY, 11797, US

(21) Appl. No.: 11/782,735

(22) Filed: Jul. 25, 2007

(30) Foreign Application Priority Data
Jul. 25, 2006 (KR) 2006-69732

(51) Int. Cl. G06F 3/038

(52) U.S. Cl. 345/212; 345/204

(57) ABSTRACT

An image display device includes a display panel, a scan driver a data driver, a refresh circuit and a timing controller. The display panel includes a plurality of pixels activated through a plurality of scan lines, and an image data signals are provided through a plurality of data lines. The image data signals to are stored as pixel voltages in the pixels. The refresh circuit is configured to sense the pixel voltages through the data lines and to output one of a first refresh voltage and a second refresh voltage to each of the data lines, to refresh the respective pixel voltage. The timing controller is configured to control the scan driver, the data driver and the refresh circuit.

### CROSS-REFERENCE TO RELATED APPLICATIONS

This application claims priority under 35 USC §119 to Korean Patent Application No. 2006-69732 filed on Jul. 25, 2006, in the Korean Intellectual Property Office (KIPO), which is incorporated by reference herein in its entirety.

### BACKGROUND OF THE INVENTION

1. Field of the Invention

The present invention relates to an image display device, and more particularly to an image display device including a refresh circuit and a method of refreshing pixel voltages in a display panel.

2. Description of the Related Art

Image display devices exist in a variety of forms, including a cathode ray tube (CRT) and a flat board display. The flat board display includes a liquid crystal display (LCD), plasma display panel (PDP). The flat board display also includes devices such as a field emission display (FED), an electro luminescence display (ELD), a vacuum fluorescent display (VFD), and light emitting diode 203 (LED), etc.

An LCD is made by injecting liquid crystal between two thin glass plates. An LCD displays a diagram, a character or an image by changing the molecular arrangement of the liquid crystal by a voltage difference of the glass plates to generate light-and-shade patterns.

LCDs are classified into a simple matrix form (or a passive matrix form) and an active matrix form. A twisted nematic (TN) LCD and a super twisted nematic (STN) LCD are of the simple matrix form. The element configuration of the simple matrix form is simple because scanning electrodes and the signal electrodes are arranged in an x-y array, and each crossing point of the scanning electrodes and the signal electrodes is a pixel in the array.

A thin film transistor-LCD (TFT-LCD) is in each pixel in the LC) of the active matrix form. The active matrix LCD is used as a high quality image display and as a color display because a thin film transistor (TFT) directly drives to each pixel.

To construct a liquid crystal cell a liquid crystal layer is formed in a narrow space of the two glass plates. Each of the two glass plates has transparent electrodes.

In an LCD having the simple matrix form, all pixels of the simple matrix form are coupled electrically and a pixel liquid crystal is directly driven by an electrode. Therefore, a display signal transmitted to a selected scanning electrode generates a leakage current to a non-selected scanning electrode. Because of the leakage current a degradation of the light-and-shade and image quality may occur. The leakage current may be decreased by rapidly changing 203 the molecular arrangement of the liquid crystal. Thus, a STN liquid crystal is developed and the STN liquid crystal is mainly used in a LCD device of the simple matrix form.

An active matrix type LCD includes one switch (TFT) per pixel so that a signal is completely suppressed from a pixel not selected in order to prevent an inference between the scanning electrodes that occurs in the LCD device of the simple matrix form. To form the active matrix on a big glass plate, t active elements (switches, TFTs) are formed as thin-film. The thin-filmed elements may be a thin film diode (TED) or thin film transistor (TFT) A panel using TEDs has poor performance compared to a panel using TFTs. The panel using TFTs is manufactured by a relatively complex process and has a relatively complex configuration. The panel using TFTs however, has better switching characteristic than the panel using TFTs. Therefore, the LCD device of an active matrix form capable of displaying the high-quality image with stability can to be implemented by combining the TFT and TN liquid crystals.

FIG. 1 is a block diagram illustrating a conventional image display device.

Referring to FIG. 1, an image display device 100 includes a display panel 110, a scan driver 120, a data driver 130, a frame memory 140, a timing controller 150 and host interface 160.

The display panel 110 has an array structure, in which a plurality of pixels is arranged in a plurality of columns and a plurality of rows. Each of the pixels includes a liquid crystal element that is formed by injecting a liquid crystal (LC) between the top (glass) plate and the bottom (glass) plate, and constructing a switching element such as a thin film transistor (TFT) on one of the plates. The switching element is configured to electrically connect the liquid crystal element to a data line. In a color LCD, one pixel is configured with three LC cells, where each cell includes one liquid crystal element and one switching element, because each of the image data is composed of R, G, and B (three-color) data.

The scan driver 120 is electrically coupled to control electrodes of the switching element in each of the pixels through a plurality of scan lines S1, S2, . . . Sm. The scan driver 120 selectively applies a scan line driving voltage to a selected scan line among a plurality of scan lines S1, S2, . . . , Sm and switching elements control electrodes of (row of) pixels coupled to the selected scan line are simultaneously turned ON.

The data driver 130 outputs image data signals synchronized with the selected row of pixels to a plurality of data lines D1, D2, . . . Dn. The data signals outputted to the data lines are stored in the liquid crystal elements as pixel voltages through the switching elements coupled to the activated scan lines. The liquid crystal molecules in the liquid crystal cells are arranged according to a difference between a pixel voltage and a common voltage VCOM in each pixel, The light-transmittance of the liquid crystal element depends upon the state of the arrangement of the liquid crystal molecules and thus, upon the image data being displayed.

An image data and a control signal received from an outside (for example, from a host device) of the image display device 100 are provided to the frame memory 140 and the timing controller 150 through the host interface 160. The timing controller 150 generates signals for controlling operation timing of the scan driver 120, the data driver 130 and the frame memory 140 in response to the received control signal. The frame memory 140 stores the image data received through the host interface 160. The stored image data is outputted row-by-row to the data lines D1, D2, . . . , Dn through the data driver 130. Generally the frame memory 140 may store image data corresponding to one frame.

The pixel voltage stored in the pixels of the display panel 110 can be changed by a leakage current over a lapse of time. Therefore, when the image data is not provided from the outside during relatively long time, a refresh of the pixel voltage is necessary by periodically applying the image data stored into the frame memory 140 to the display panel 110. In order to refresh the pixel voltage, the data driver 130 operates and repeated operation of the data driver 130 increases power consumption.

In order to solve the power consumption problem described above, Japanese patent application publication No. 2002-236477 discloses a method to of preventing a decrease of a pixel voltage due to a leakage current etc.

FIGS. 2 and 3 are circuit diagrams illustrating conventional pixel configurations for preventing a decrease of a pixel voltage due to leakage current.

Referring to FIG. 2, a pixel 10 formed at a crossing point of a scan line Dk and a data line Dk includes a storage capacitor CS as well as a switching element (e.g., TFT) TR and a liquid crystal element CL.

When the scan line Sk is activated by a scan line driving signal VS, the switching element TR is turned ON and an image data signal DATA is applied to a pixel electrode NP. A voltage of the applied image data signal DATA is stored as a pixel voltage VP by the capacitances of the storage capacitor CS and of the liquid crystal element CL.

When the scan line Sk is deactivated and thus the switching element TR is turned OFF, the pixel voltage VP decreases with lapse of time. Thus the voltage difference between the pixel voltage VP and the common voltage VCOM decreases. The storage capacitor CS is coupled to the pixel electrode NP so as to prevent or slow the decrease of the voltage difference between the pixel voltage VP and the common voltage VCOM, when the capacitance of the storage capacitor CS is relatively high, the changing of the pixel voltage VP is relatively slow.

However even when a storage capacitor having a high capacitance is used, maintaining the pixel voltage VP is limited. Also, including a storage capacitor having a high capacitance in each of the pixels decreases the aperture ratio of the pixel and increases a current load through the switching element TR.

Referring to FIG. 3, a pixel 10A formed at the crossing point of a scan line Sk and a data line Dk includes an analog amplifier (OpAmp) 15 in addition to a switching element TR and a liquid crystal element CL.

A change of a pixel voltage VP can be prevented because a predetermined voltage is constantly applied to the pixel electrode NP by the analog amp 15. However, even when the analog amp 15 is used in the pixel 10A, problems such as a decrease of an aperture ratio and an increase of power consumption may occur.

### SUMMARY OF THE INVENTION

Aspects of the invention provides a display panel including a plurality of pixels activated through a plurality of scan lines and the image data signals are provided through a plurality of data lines. The image data signals are stored as pixel voltages in the pixels. The refresh circuit is configured to sense the pixel voltages through the data lines and to output one of a first refresh voltage and a second refresh voltage to each of the data lines, to refresh the respective pixel voltage. The timing controller is configured to control the scan driver, the data driver and the refresh circuit.

Another aspect of the present invention provides a refresh circuit, an image display device including a refresh circuit and a method of refreshing a pixel voltage capable of maintaining a pixel voltage while a frame memory is disabled.

Another aspect of the present invention provides a refresh circuit, an image display device including a refresh circuit and a method of refreshing a pixel voltage capable of preventing an increase of power consumption and a decrease of aperture ratio.

Anther aspect of the present invention provides a refresh circuit, an image display device including a refresh circuit and a method of refreshing a pixel voltage capable of selectively providing a first digital (refresh) voltage corresponding to an amplified pixel voltage and a second refresh voltage corresponding to an inversion of the first refresh voltage.

In some exemplary embodiments of the present invention, an image display device includes a display panel, a scan driver, a data driver, a refresh circuit and a timing controller.

The display panel may include a plurality of pixels in which image data signals are stored as pixel voltages. The pixels are activated through a plurality of scan lines, and the image data signals are provided through a plurality of data lines. The scan driver is configured to selectively activate the scan lines and the data driver is configured to provide the image data signals through the data lines. The refresh circuit is configured to sense the pixel voltages through the data lines and is configured to output a selected one of a first refresh voltage and a second refresh voltage to each of the data lines to refresh the respective pixel voltage. The first refresh voltage corresponds to an amplified voltage of the sensed pixel voltage, the second refresh voltage corresponds to an inverted-amplified voltage of the sensed pixel voltage. The timing controller is configured to control the scan driver, the data driver and the refresh circuit.

The refresh circuit may include a plurality of analog-to-digital converters (ADCS) respectively coupled to the data lines, each of the ADs include a sense amp unit a precharge unit and a switching unit. The sense amp unit configured to sense the pixel voltage through a first terminal and generate the first (and optionally the second refresh voltages) through the first terminal (and a second terminal), the precharge unit is configured to set the first (and second) terminal of the sense amp unit to a precharge voltage prior to sensing the pixel voltage on the data line. A switching unit is configured to control the timing for connecting the data line and the sense amp unit so that the pixel voltage on the data line is applied to the first terminal and so that the selected one of the first and second refresh voltages is outputted to the data line.

The precharge unit may be configured to set the first and second terminals to the precharge voltage regardless of activation of the scan line while the sense amp unit is electrically disconnected to the data line.

The switching unit may include a first switch configured to control a timing for connecting the data line and the first terminal.

The first switch may be turned ON to apply the pixel voltage on the data line to the first terminal that is set to the precharge voltage and then to output the first refresh voltage of the first terminal to the data line.

The switching unit may further include a second switch configured to control the timing for connecting the data line and the second terminal.

The first switch may be turned ON to apply the pixel voltage on the data line to the first terminal that is set to the precharge voltage, and the second switch may be turned ON to output the second refresh voltage of the second terminal to the data line.

The switching unit may further include a third switch configured to control an electrical connection of the data line and the data driver, and the third switch is turned OFF during an operation of the refresh circuit,

All of the scan lines may be sequentially activated and all of the pixel voltages of the display panel may be periodically refreshed.

A selected portion of the scan lines may be sequentially activated, and a portion of the pixel voltages corresponding to the activated scan lines may be periodically refreshed.

The display panel may be a thin film transistor (TFT) liquid crystal panel.

In other embodiments of the present invention, a refresh circuit includes a plurality of analog-to-digital converters (ADCs) respectively coupled to a plurality of data lines. Each of the ADs includes a sense amp unit, a precharge unit and a switching unit. The sense amp unit configured to sense a pixel voltage on a data line through a first terminal and to generate a first refresh voltage through the first terminal (and optionally, a second refresh voltage through a second terminal). The first refresh voltage corresponds to an amplified voltage of the sensed pixel voltage, and the second refresh voltage corresponds to an inverted-amplified voltage of the sensed pixel voltage. The precharge unit is configured to set the first and second terminals of the sense amp unit to a precharge voltage prior to sensing the pixel voltage on the data line. The switching unit is configured to control the timing for connecting the data line and sense amp unit so that the pixel voltage on the data line is applied to the first terminal and one of the first refresh voltage and the second refresh voltage is outputted to the data line.

The precharge unit may be configured to set the first and second terminals to the precharge voltage while the sense amp unit is electrically disconnected to the data line.

The switching unit may include a first switch configured to control a timing for connecting the data line and the first terminal

The first switch may be turned ON to apply the pixel voltage on the data line to the first terminal that is set to the precharge voltage and to output the first refresh voltage of the first terminal to the data line.

The switching unit may further include a second switch configured to control the timing for connecting the data line and the second terminal.

The first switch may be turned ON to apply the pixel voltage on the data line to the first terminal that is set to the precharge voltage and the second switch may be turned ON to output the second refresh voltage of the second terminal to the data line.

The switching unit may include at least one transmission gate being coupled between the data line and the sense amp unit,

The sense amp unit may include a first p-channel metal oxide semiconductor (PMOS) transistor coupled between a first power voltage and a first node and including a gate to which an inverted signal of a sense amp control signal is applied; a second PMOS transistor coupled between the first node and the first terminal, and including a gate being coupled to the second terminal; a first n-channel metal oxide semiconductor (NMOS) transistor coupled between the first terminal and a second node, and including a gate coupled to the second terminal; a third PMOS transistor coupled between the first node and the second terminal, and including a gate coupled to the first terminal; a second NMOS transistor coupled between the second terminal and the second node, and including a gate coupled to the first terminal, and a third NMOS transistor coupled between the second node and a second power voltage, and including a gate to which the sense amp control signal is applied.

The precharge voltage may correspond to about a medium voltage between the first power voltage and the second power voltage.

In still other embodiments of the present invention, a method of refreshing a pixel voltage, in which the pixel voltage is respectively stored in a plurality of pixels included in a display panel, and the pixels are coupled to a plurality of scan lines and a plurality of data lines, includes applying the pixel voltages to the data lines by selectively activating the scan lines; sensing the pixel voltages on the data lines; generating a first refresh voltage corresponding to an amplified voltage of the sensed pixel voltage (and optionally generating a second refresh voltage corresponding to an inverted-amplified voltage of the sensed pixel voltage), respectively; and outputting one of the first refresh voltage and the second refresh voltage to each of the data lines to refresh the pixel voltage.

Sensing the pixel voltage may include providing a precharge voltage for detecting a logic level of the pixel voltage, and determining the logic level of the pixel voltage by detecting the difference between the pixel voltage applied to the data line and the precharge voltage,

Providing the precharge voltage may be performed when the pixel voltage is applied to the data line or after the pixel voltage is applied to the data line.

Outputting one of the first and second refresh voltages to each of the data lines may correspond to outputting the first refresh voltage to the data line through a path identical to a path for sensing the pixel voltage on the data line.

Outputting the second refresh voltages to each of the data lines may correspond to outputting the second refresh voltage to the data line through a path different from a path for sensing the pixel voltage on the data line.

All of the scan lines may be sequentially activated, and all of the pixel voltages of the display panel may be periodically refreshed.

A portion of the scan lines may be sequentially activated, and a portion of the pixel voltages corresponding to the activated scan lines may be periodically refreshed.

Therefore, power consumption may be decreased because a refresh operation is performed when a frame memory is in a disable state, and an increase of power consumption and a decrease of an aperture ratio may be prevented by using analog-to-digital converters.

### BRIEF DESCRIPTION OF THE DRAWINGS

FIG. 1 is a block diagram illustrating a conventional Image display device.

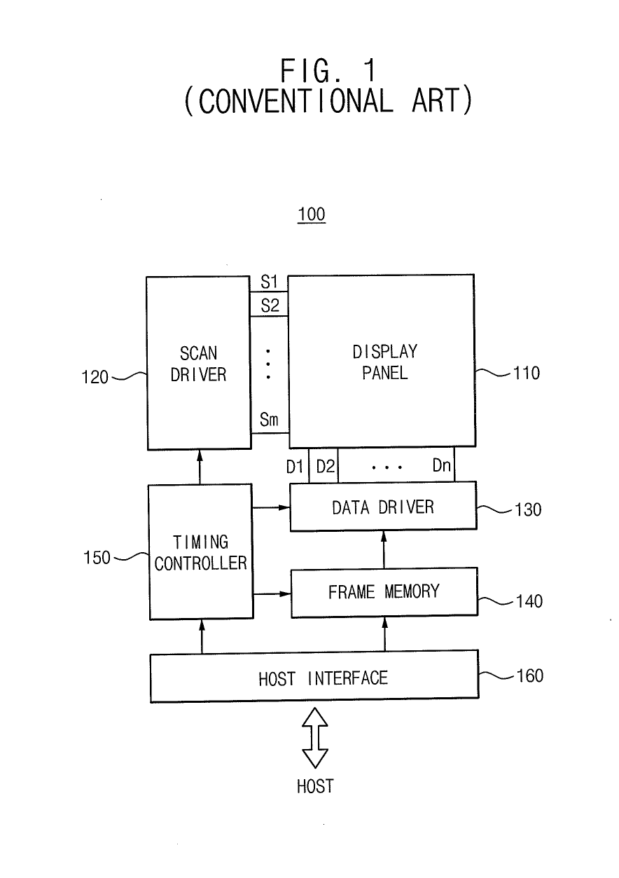

FIGS. 2 and 3 are circuit diagrams illustrating conventional pixel configuration for preventing a decrease of a pixel voltage.

FIG. 4 is a block diagram illustrating an image display device according to an exemplary embodiment of the present invention.

FIG. 5 is a block diagram illustrating an exemplary refresh circuit for use in the device of FIG. 4.

FIG. 6 is a circuit diagram illustrating an exemplary implementation of an analog-to digital converter (ADC) included in the refresh circuit of FIG. 5.

FIG. 7 is a timing diagram of control signals for describing an operation of a refresh circuit of FIGS. 5 and 6.

FIG. 8 is a timing diagram of control signals for describing another operation of a refresh circuit of FIGS. 5 and 6.

FIG. 9 is a circuit diagram illustrating another exemplary implementation of an ADC included in the refresh circuit of FIG. 5.

Embodiments of the present invention now will be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### DETAILED DESCRIPTION OF EXEMPLARY EMBODIMENTS OF THE INVENTION

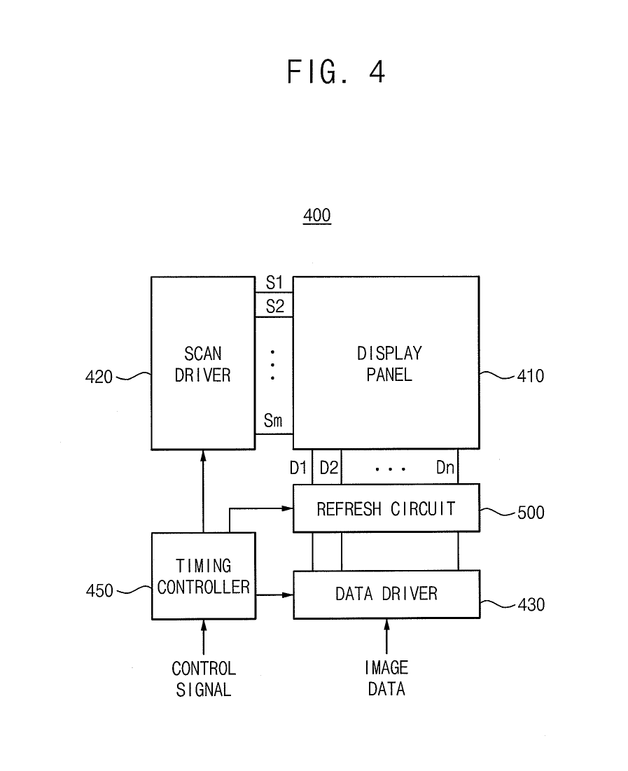

FIG. 4 is a block diagram illustrating an image display device according to an exemplary embodiment of the present invention.

Referring to FIG. 4, the image display device 400 includes a display panel 410, a scan driver 420, a data driver 430, a timing controller 450 and a refresh circuit 500.

The display panel 410 includes a plurality of pixels. The pixels are activated through a plurality of scan lines S1, S2, . . . Sm, and respectively store image data signals, which are provided through a plurality of data lines D1, D2, . . . , Dn, as pixel voltages.

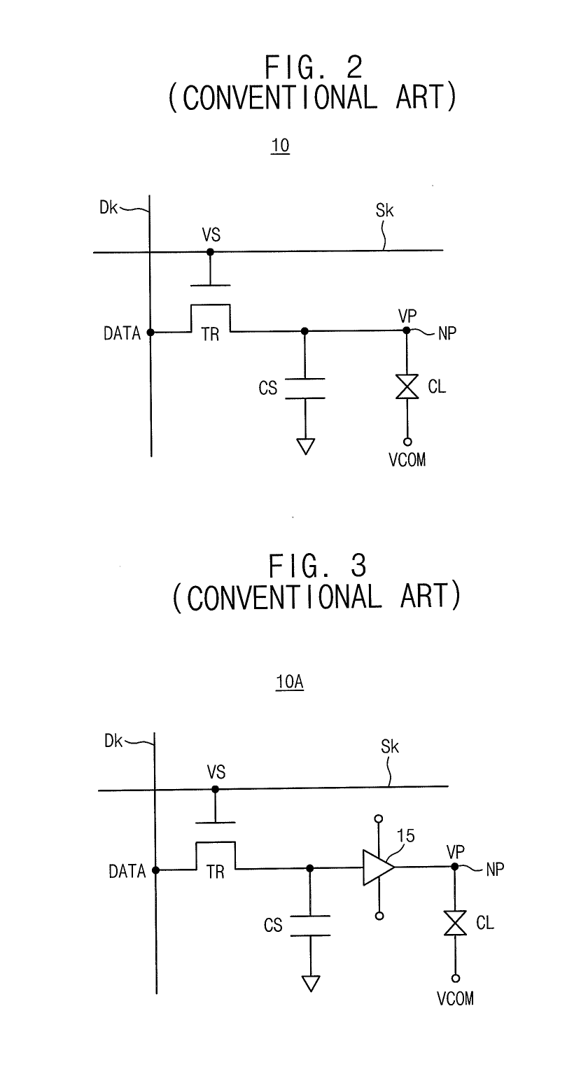

The display panel 410 has an array structure in which the pixels are arranged in a plurality of columns and a plurality of rows. Each of the pixels includes a liquid crystal (LC) element that is formed by injecting a liquid crystal between a top plate and a bottom plate, and a switching element such as a thin film transistor (TFT). The switching element is configured to connect the liquid crystal element to a data line. In a color liquid crystal display (LCD), one pixel includes three cells because each pixel of the image data includes R, G, B (three-color) data. The configuration of the pixels formed in the display panel 410 may include but is not limited to the pixel designs illustrated in FIGS. 2, 3 and 5. The pixel formed in the display panel 410 may include an arbitrary switching element and a liquid crystal element. For example, a thin film transistor (TFT) may be used as the switching element.

The scan driver 420 selectively activates scan lines S1, S2, . . . , Sm. That is, switching elements control electrodes of which are coupled to the selected scan line are turned ON by a scan line driving signal,

When the selected scan line is activated, the image data signals of the data lines are stored in liquid crystal elements as pixel voltages through switching elements. Liquid crystal molecules in the liquid crystal element are arranged by the difference between a pixel voltage and a common voltage VCOM, and the light-transmittance of the liquid crystal element is determined by the arrangement of the liquid crystal molecules,. Image data is displayed according to the light-transmittance.

In addition, when the selected scan line is activated, the switching elements in the selected row of pixels are turned ON.

The image data signals may be received from the external (for example, a host device). The received image data signals may be stored into a frame memory, and the stored image data signals are provided to the data driver 430. The stored image data signals are provided row-by-row to the data lines D1, D2, . . . , Dn through the data driver 430. The data driver 430 outputs the image data signals to the data lines D1 through Dn. The image data signals are stored in the pixels coupled to each of the data lines D1, D2, . . . Dn as pixel voltages.

The data driver 430 may further include an output buffer (or line register) that performs buffering of image data signals corresponding to a row and outputs the image data signals row-by-row. An image display device operating in a full color mode may include a digital-to-analog converter (DAC) for generating analog gray-scale voltages. The data driver 430, the frame memory, and other peripheral circuits may be integrated on a single chip.

The timing controller 450 generates timing control signals for controlling the scan driver 420, the data driver 430 and the refresh circuit 500. The timing controller 430 generates the timing control signals in response to a control signal received from an external device, for example, from a host device.

The refresh circuit 500 senses the pixel voltages through the data lines D1, D2, . . . , Dn and outputs one of a first refresh voltage and a second refresh voltage to each of the data lines to refresh the pixel voltages. The first refresh voltage corresponds to the amplified voltage of the sensed pixel voltage and the second refresh voltage corresponds to the inverted-amplified voltage of the sensed pixel voltage. Exemplary configurations and the operation of the refresh circuit 500 are described as follows.

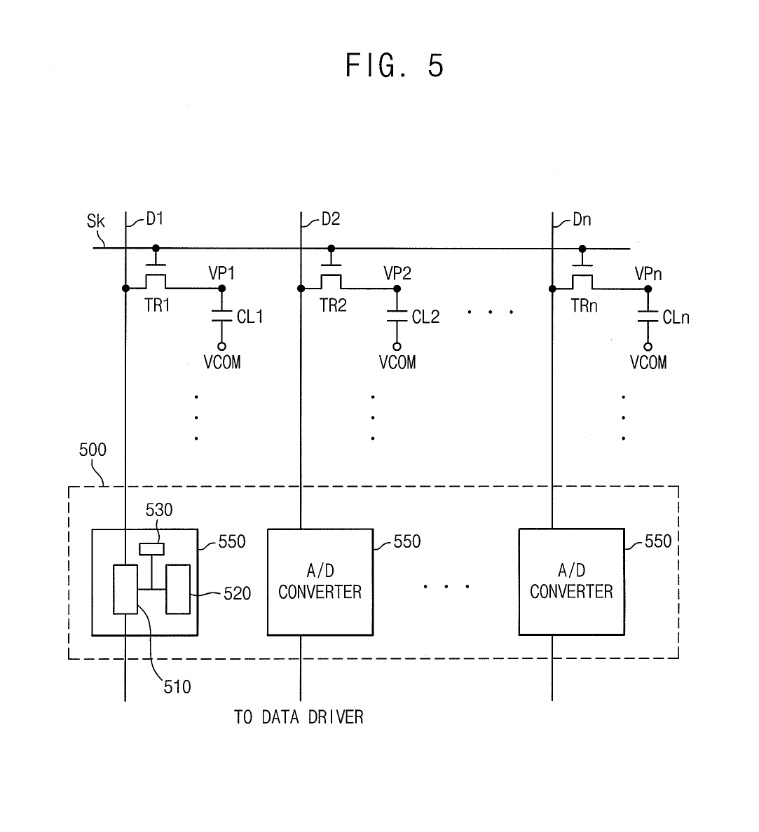

FIG. 5 is a block diagram illustrating a refresh circuit according to an exemplary embodiment of the present invention.

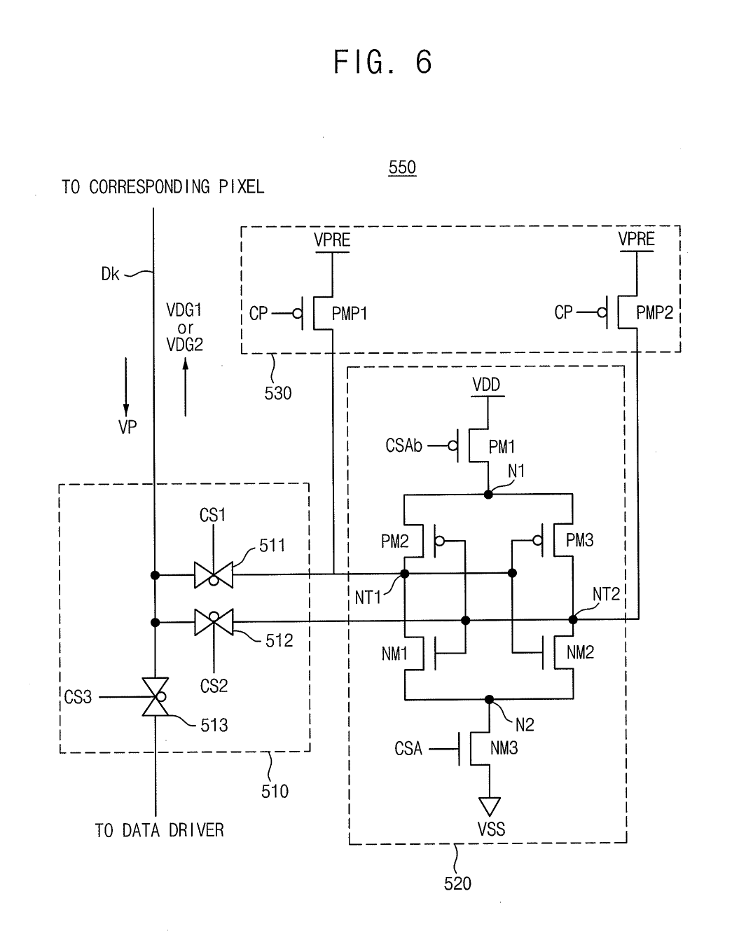

Referring to FIG. 5, the refresh circuit 500 includes a plurality of analog-to-digital converters (ADs). Each of the ADCs includes (see FIG. 6) a switching unit 510: a sense amp unit 520 and a precharge unit 530.

FIG. 6 is a circuit diagram illustrating an example of an analog-to-digital converter (ADC) included in the refresh circuit of FIG. 5.

The sense amp unit 520 senses a corresponding one of the pixel voltages VP1, VP2, . . . , VPn through a first terminal and amplifies the sensed pixel voltage. The sense amp unit 520 generates the first refresh voltage VDG1 through the first terminal that is a sensing path and generates the second refresh voltage to VDG2 through the second terminal.

The precharge unit 530 set the first and second terminals of the sense amp unit 520 to a precharge voltage before the sense amp unit 520 senses the pixel voltage on the data line so that the pixel voltage on the data lines may be precisely sensed.

The timing for connecting the data line and the sense amp unit 520 is controlled by the switching unit 510. Thus, the timing for applying the pixel voltage on the data line to the first terminal and a timing for outputting one of the first and second refresh voltages to the data line are controlled by an ON/OFF operation of the switching unit 510.

Referring to FIG. 6, the ADC 550 includes the switching unit 510, the sense amp unit 520 and the precharge unit 530.

The sense amp unit 520 includes first through third p-channel metal oxide semiconductor (PMOS) transistors PM1, PM2 and PM3, and first through third n-channel metal oxide semiconductor (NMOS) transistor NM1, NM2 and NM3.

The first PMOS transistor PM1 is coupled between a first power voltage VDD and a first node N1 and includes a gate to which an inverted sense amp control signal CSAb is applied. The second PMOS transistor PM2 is coupled between the first node N1 and the first terminal NT1 and includes a gate coupled (cross connected) to the second terminal NT2. The first NMOS transistor NM1 is coupled between the first terminal NT1 and a second node N2 and includes a gate coupled (cross connected) to the second terminal NT2. The third PMOS transistor PM3 is coupled between the first node N1 and the second terminal NT2 and includes a gate coupled (cross connected) to the first terminal NT1. The second NMOS transistor NM2 is coupled between the second terminal NT2 and the second node N2 and includes a gate coupled (cross connected) to the first terminal NT1. The third NMOS transistor NM3 is coupled between the second node N2 and a second power voltage VSS and includes a gate to which a sense amp control signal GSA is applied.

The sense amp unit 520 senses the pixel voltage VP on the data line Dk through the first terminal NT1 in response to the sense amp control signal GSA and the inverted sense amp control signal GSAb, and amplifies the sensed pixel voltage. The sense amp unit 520 generates the first refresh voltage VDG1 through the first terminal NT1 that is the sensing path, and generates the second (inverted first) refresh voltage VDG2 through the second terminal NT2. The first refresh voltage corresponds to the amplified voltage of the sensed pixel voltage VP and the second refresh voltage corresponds to the inverted-amplified voltage of the sensed pixel voltage VP.

Hereinafter, the operation of the sense amp unit 520 in FIG, 6 is described.

When the pixel voltage VP on the data line Dk is at a high level, the sense amp unit 520 senses a higher voltage than a precharge voltage VPRE through the first terminal NT1. At this time, the high level is applied to the gates of the third PMOS transistor PM3 and the second NMOS transistor NM2 because the gates of the third PMOS transistor PM3 and the second NMOS transistor NM2 are coupled to the first terminal NT1. Therefore, the second refresh voltage VDG2 of the second terminal NT2 is substantially equal to the second power voltage VSS because the third PMOS transistor PM3 is turned OFF and the second NMOS transistor NM2 is turned ON. Thus, the second refresh voltage VDG2 corresponds to the inverted-amplified voltage of the pixel voltage VP on the data line Dk. In addition, a low level is applied to the gates of the second PMOS transistor PM2 and the first NMOS transistor NM1 because the gates of the second PMOS transistor PM2 and the first NMOS transistor NM1 are coupled to the second terminal NT2. Therefore, the first refresh voltage VDG1 of the first terminal NT1 is substantially equal to the first power voltage VDD because the second PMOS transistor PM2 is turned ON and the second NMOS transistor NM1 is turned OFF. Thus, the first refresh voltage VDG1 corresponds to the amplified voltage of the pixel voltage VP on the data line Dk.

By contrast, when the pixel voltage VP on the data line Dk is a low level, the sense amp unit 520 senses a lower voltage than a precharge voltage VPRE through the first terminal NT1. At this time, the low level is applied to the gates of the third PMOS transistor PM3 and the second NMOS transistor NM2 because the gates of the third PMOS transistor PM3 and the second NMOS transistor NM2 are coupled to the first terminal NT1. Therefore, the second refresh voltage VDG2 of the second terminal NT2 is substantially equal to the first power voltage VDD because the third PMOS transistor PM3 is turned ON and the second NMOS transistor NM2 is turned OFF. Thus, the second refresh voltage VDG2 corresponds to the inverted-amplified voltage of the pixel voltage VP on the data line Dk. And meanwhile, a high level is applied to the gates of the second PMOS transistor PM2 and the first NMOS transistor NM1 because the gates of the second PMOS transistor PM2 and the first NMOS transistor NM1 are coupled to the second terminal NT2. Therefore, the first refresh voltage VDG1 of the first terminal NT1 is substantially equal to the second power voltage VSS because the second PMOS transistor PM2 is turned OFF and the second NMOS transistor NM1 is turned ON. Thus the first refresh voltage VDG1 corresponds to the amplified voltage of the pixel voltage VP on the data line Dk.

The precharge unit 530 may be implemented with transistors PMP1 and PMP2. The transistors PMP1 and PMP2 perform ON/OFF (switching) operation in response to the precharge control signal CP. When the transistors PMP1 and PMP2 are turned ON, the precharge voltage VPRE is provided to the both the first terminal NT1 and the second terminal NT2. The precharge unit 530 sets the first terminal NT1 and the second terminal NT2 of the sense amp unit 520 to the precharge voltage VPRE before the sense amp unit 520 senses the pixel voltage VP on the data line Dk so that the pixel voltage on the data line Dk may be precisely sensed.

The switching unit 510 controls the timing for connecting the data line Dk and the sense amp unit 520 The switching unit 510 controls the timing for applying the pixel voltage VP on the data line Dk to the first terminal NT1 and the timing for outputting a selected one of the first refresh voltage VDG1 and the second refresh voltage VDG2 to the data line Dk by an ON/OFF (switching) operation of switches 511 and 512.

The switching unit 510 includes a first switch 511 that controls the timing for connecting the data line Dk and the first terminate NT1. The first switch 511 performs an ON/OFF (switching) operation in response to a first switch control signal CS1. The first switch 511 is turned ON so that the pixel voltage VP on the data line Dk will be applied to the first terminal NT1 (previously set to the precharge voltage VPRE). Also, the first switch 511 is turned ON so that the first refresh voltage VDG1 generated through the first terminate NT1 is outputted to the data line Dk. The first refresh voltage corresponds to the amplified voltage of the sensed pixel voltage VP.

The switching unit 510 may further include a second switch 512 that controls the timing for connecting the data line Dk and the second terminal NT2. The second switch 512 performs an ON/OFF (switching) operation in response to a second switch control signal CS2. The first switch 511 is turned on so that the pixel voltage VP on the data line Dk will be applied to the first terminal NT1 (previously set to the precharge voltage VPRE). The second switch 512 is also turned ON so that the second refresh voltage VDG2 generated through the second terminal NT2 is outputted to the data line Dk. The second refresh voltage VDG2 corresponds to the inverted-amplified voltage of the sensed pixel voltage VP.

As described above, the amplified voltage and the inverted-amplified voltage are outputted alternately by using the first switch 511 and the second switch 512 so that a refresh operation is performed. Therefore, a degradation of a liquid crystal element included in the pixel can be prevented.

Also, the switching unit 510 may further include a third switch 513 that controls the timing for connecting the data line Dk and the data driver 430. The third switch 513 may be turned OFF during an operation of the refresh circuit 500 in response to a third switch control signal CS3. The timing controller 450 may generate a control signal for disabling the data driver 430 while the refresh circuit 500 operates. In this case, a data line coupled to the data driver 430 is in a floating state and thus the third switch 513 may be omitted.

Each of the first, second and third switches 511, 512 and 513 may be implemented with transmission gates (pass-gates) each including a PMOS transistor and a NMOS transistor and thus may be turned ON/OFF in response to a control signal and an inverted control signal.

FIG. 4 illustrates the refresh circuit 500 disposed between the display panel 410 and the data driver 430. However, the refresh circuit 500 may be located at the side of the display panel 410 opposite the data driver 430. Thus, the display panel 410 may be located between the refresh circuit 500 and the data driver 430. In this case, the third switch 513 may be located on the data line between the display panel 410 and the data driver 430.

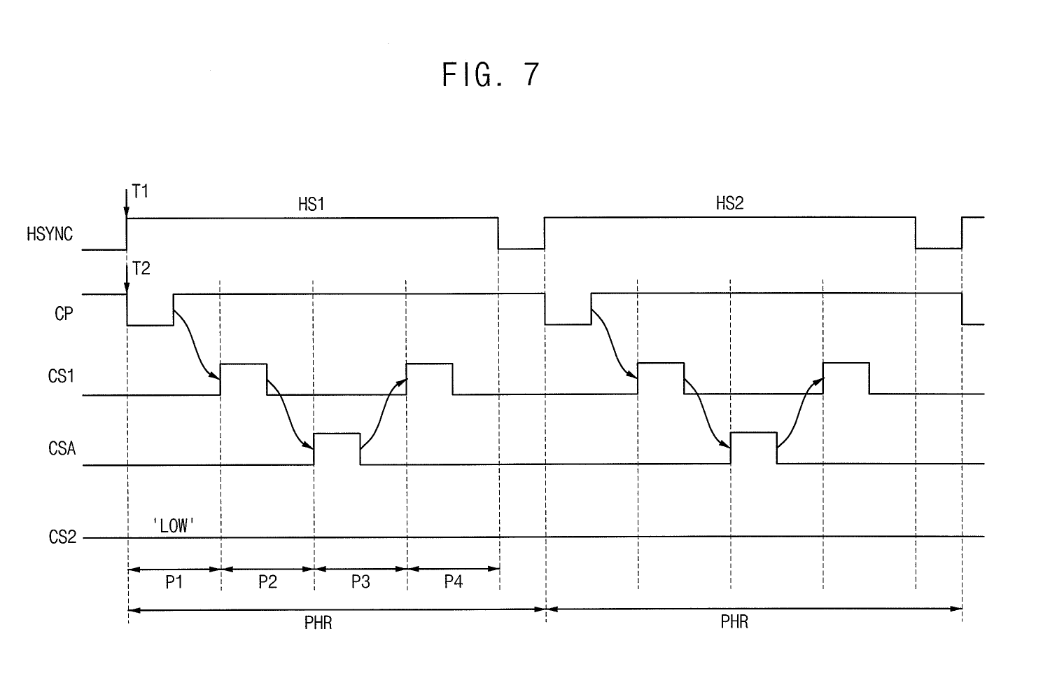

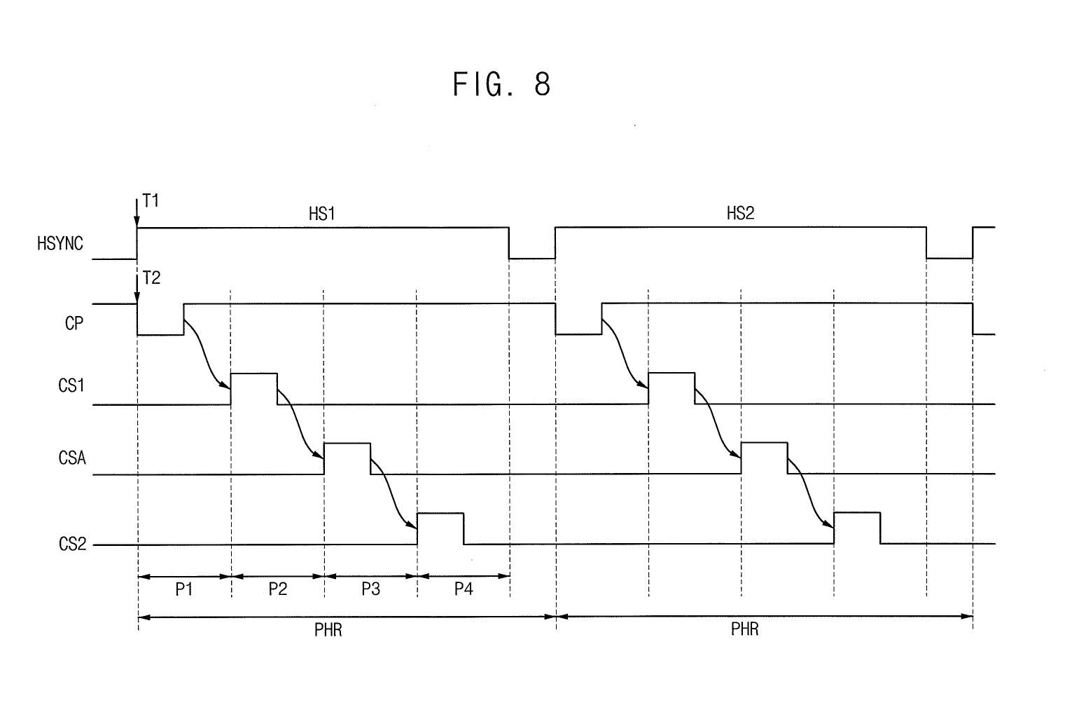

Hereinafter, the operation of the refresh circuit 500 is described with reference to FIGS. 7 and 8.

FIG. 7 is a timing diagram of control signals for describing an exemplary operation of a refresh circuit of FIGS. 5 and 6.

As illustrated in FIG. 7, the refresh circuit 500 (FIGS. 5 and 6) performs a refresh operation to refresh the pixel voltage stored in the display panel 410 row-by-row according to a row refresh period PHR. Generally, a horizontal synchronization signal HSYNC is used for controlling the timing when the display panel 410 receives an image data signal. The horizontal synchronization signal HSYNC may be conveniently used for generating the row refresh period PHR. The row refresh period PHR may be different from the period by which the to display panel 410 receives the image data signal row-by-row. For example, a first scan line may be activated by a first scan line driving signal HS1, and a pixel voltage corresponding to the first scan line is refreshed. Next, a second scan line may be activated by a second scan line driving signal HS2, and a pixel voltage corresponding to the second scan line is refreshed. As described above, scan lines are sequentially activated and a refresh operation is performed row-by-row corresponding to the activated scan lines. The first and second scan line driving signals HS1 and HS2 are individual signals respectively provided to the first and the second scan lines. However, in FIG. 7, the first and second scan line driving signals HS1 HS2 are illustrated as one signal for convenience of illustration.

The scan lines may be sequentially activated and the pixel voltages of the display panel may be periodically refreshed. However, according to an exemplary embodiment, a portion of the scan lines may be sequentially activated and the portion of the pixel voltages corresponding to the activated scan lines may be periodically refreshed. Thus, the pixel voltages corresponding to a portion of the rows of the display panel 410 to (repeatedly) display relatively static information (e.g., date and time information, “remaining battery” information etc.) may be refreshed and pixel voltages corresponding to the rest of rows of the display panel 410 may be erased.

During one row refresh period PHR a precharge operation, a switching operation for applying the pixel voltage VP on the data line Dk to the sense amp unit 520, sense amp operation, and a switching operation for outputting the amplified voltage to the data line DR are performed to In FIG, 7, time-segment P1 is a precharge operation time time-segment P2 is a switching operation time for applying the pixel voltage VP on the data line Dk to the sense amp unit 520, segment PS is a sense amp operation time, and segment P4 is a switching operation time for outputting the amplified voltage to the data line DR.

Each of an activation levels (high or low) of the precharge control signal CP, the first switch control signal CS1, sense amp control signal CSA and the second switch control signal CS2 corresponds to the ADs in FIG. 6, and the activation levels may be varied according to the configuration of the ADC.

In FIG. 7, the activation time point T1 of the scan line driving signal HS1 and the activation time point T2 of the precharge control signal CP are the same (simultaneous with each other). However, the activation time point T2 of the precharge control signal CP may be independent of the activation time point T1 of the scan line driving signal HS1. Thus, the activation time point 12 of the precharge control signal CP may be before the activation time point T1 of the scan line driving signal HS1 and the activation time point T1 of the scan line driving signal HS1 may be before the activation time point T2 of the precharge control signal CP. The precharge operation is performed with respect to the first and second terminals NT1 and NT2 (not the data line Dk) while the data line Dk and the sense amp unit 520 are electrically disconnected by turn-OFF of the switches 511 and 512 (see FIG. 6. Therefore, a timing margin of the precharge operation may be secured. However, outputting the pixel voltage VP to the data line Dk by the activation of the scan line driving signal needs to occur prior to the switching operation time segment P2 of the first switch 511.

The timing diagram of FIG. 7 illustrates the case where the first switch 511 is turned ON so that the pixel voltage VP on the data line Dk is applied to the first terminal NT1 (precharged to the precharge voltage in advance), and the first switch 511 is turned ON so that the first refresh voltage VDG1 generated through the first terminal NT1 is outputted to the data line Dk. Thus, a combination of the control signals in FIG. 7 corresponds to the case where an amplified voltage of the sensed pixel voltage VP is outputted as a refresh voltage.

FIG. 8 is a timing diagram of control signals for describing another operation of the refresh circuit of FIGS. 5 and 6.

The timing diagram of FIG. 8 illustrates the case where the first switch 511 is turned ON so that the pixel voltage VP on the data line Dk is applied to the first terminal NT1 (precharged to the precharge voltage in advance), and the second switch 512 is turned ON so that the second refresh voltage VDG2 generated through the second terminal NT2 is outputted to the data line Dk. Thus, a combination of the control signals in FIG. 8 corresponds to the case where an inverted-amplified voltage of the pixel voltage VP is outputted as a refresh voltage. As described above, the amplified voltage and the inverted-amplified voltage may be outputted a alternately by using the first switch 511 and the second switch 512, thereby preventing a degradation of a liquid crystal element included in the pixel.

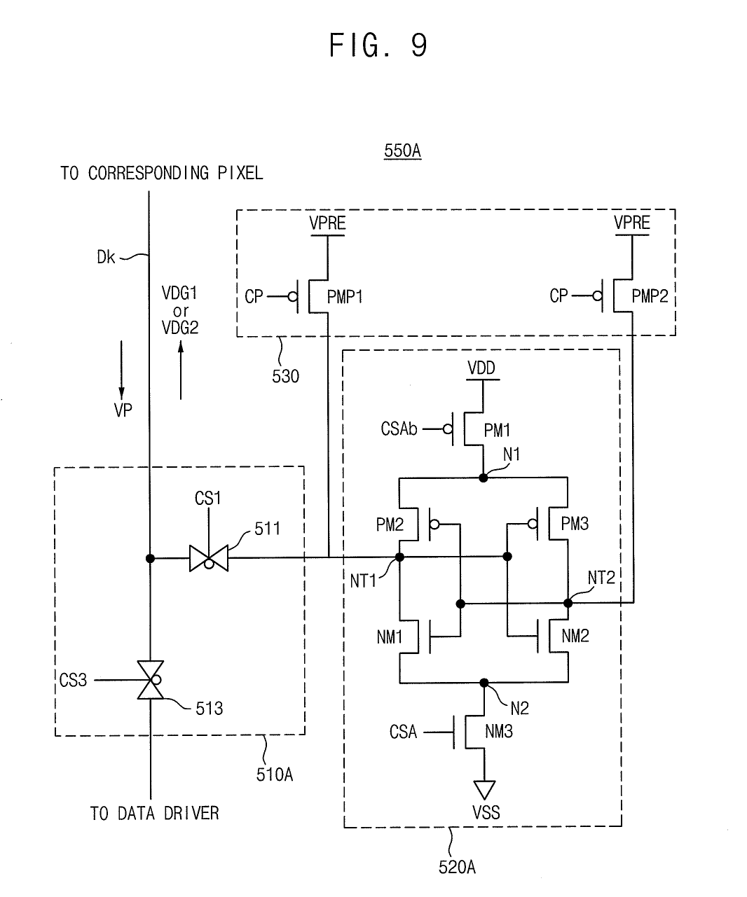

FIG. 9 is a circuit diagram illustrating another exemplary implementation of an ADC 550 included in the refresh circuit 500 of FIG. 5.

The ADC 550A in FIG. 9 differs from that 550 in FIG. 6 in that the ADC 55 A in FIG.9 does not include the second switch 512, and there is no path connecting the data line Dk to the second terminal NT2. Thus, in cases where the degradation of the liquid element is relatively low, the ADC 550A of FIG. 9 may be used in the refresh circuit 500 so that the refresh circuit 500 has relatively simple configuration.

Referring back to FIG. 8, with the omission in FIG. 9 of the switch control signal CS2, the operation of the ADC 550A is substantially the same as described with respect to the ADC 550 of FIGS. 6.

The refresh circuit and the method of the present invention may be applied to a TFT-LCD having an active matrix form. However, the present invention is not limited to the TFT-LCD, the refresh circuit and the method may be applied to a display panel having pixels including an arbitrary switching element and a liquid crystal element.

The refresh circuit, a display device including the refresh circuit and the method of refreshing a pixel voltage according to exemplary embodiments of the present invention may refresh the pixel voltages stored in a display panel while the frame memory is disabled, thereby decreasing power consumption.

Also, the refresh circuit, the display device including the refresh circuit and the method of refreshing the pixel voltage according to exemplary embodiments of the present invention may prevent an increase of power consumption and a decrease of the aperture ratio by using a row of ADCs corresponding to a row of pixels.

Also, the refresh circuit, the display device including the refresh circuit and the method of refreshing a pixel voltage according to exemplary embodiments of the present invention may be implemented with a relatively simple configuration, and a degradation of a liquid crystal element may be prevented.

Having thus described exemplary embodiments of the present invention, it is to be understood that the invention defined by the appended claims is not to be limited by particular details of examples set forth in the above description as many variations apparent to persons skilled in the art are possible without departing from the spirit or scope of the invention as hereinafter claimed.

What is claimed is:

1. An image display device comprising:
a display panel including a plurality of pixels in which image data signals are stored as pixel voltages, the pixels being activated through a plurality of scan lines, the image data signals being provided through a plurality of data lines;
a scan driver configured to selectively activate the scan lines;
a data driver configured to provide the image data signals through the data lines; and
a refresh circuit configured to refresh the respective pixel voltages in a row of pixels.

2. The image display device of claim 1, wherein the refresh circuit is configured to sense the pixel voltages through the data lines in a precharged state and configured to output one of a first refresh voltage and a second refresh voltage to each of the data lines, the first refresh voltage corresponding to an amplified voltage of the sensed pixel voltage, the second refresh voltage corresponding to an inverted-amplified voltage of the sensed pixel voltage; and further comprising,
a timing controller configured to control the scan driver, the data driver and the refresh circuit.

3. The image display device of claim 1 wherein the refresh circuit includes a plurality of analog-to-digital converters (ADCs) respectively coupled to the data lines, each of the ADCs comprising:
a sense amp unit configured to sense the pixel voltage through a first terminal and generate the first and the second refresh voltages through the first terminal and a second terminal; and
a switching unit configured to control a timing for connecting the data line and the sense amp unit so that the pixel voltage on the data line is applied to the first terminal and one of the first and second refresh voltages is outputted to the data line.

4. The image display device of claim 3, further comprising a precharge unit configured to set the first and second terminals of the sense amp unit to a precharge voltage prior to sensing the pixel voltage on the data line, wherein the precharge unit is configured to set the first and second terminals to the precharge voltage regardless of activation of the scan line while the sense amp unit is electrically disconnected to the data line.

5. The image display device of claim 3, wherein the switching unit includes a first switch configured to control a timing for connecting the data line and the first terminal.

6. The image display device of claim 5, wherein the first switch is turned ON to apply the pixel voltage on the data line to the first terminal that is set to the precharge voltage and to output a first refresh voltage of the first terminal to the data line.

7. The image display device of claim 5, wherein the switching unit further includes a second switch configured to control a timing for connecting the data line and the second terminal.

8. The image display device of claim 7, wherein the first switch is turned ON to apply the pixel voltage on the data line to the first terminal precharged to the precharge voltage, and the second switch is turned ON to output a second refresh voltage of the second terminal to the data line.

9. The image display device of claim 7, wherein the switching unit further includes a third switch configured to control an electrical connection of the data line and the data driver, the third switch being turned OFF during an operation of the refresh circuit.

10. The image display device of claim 1, wherein a portion of the scan lines are sequentially activated, and the pixel voltages corresponding to the activated portion of the scan lines are periodically refreshed.

11. The image display device of claim 1, wherein the display panel is a thin film transistor (TFT) liquid crystal panel.

12. A refresh circuit including a plurality of analog-to-digital converters (ADCs) respectively coupled to a plurality of data lines, each of the ADCs comprising:
a sense amp unit configured to sense a pixel voltage on a data line through a first terminal and to generate a first refresh voltage through the first terminal and a second refresh voltage through a second terminal, the first refresh voltage corresponding to an amplified voltage of the sensed pixel voltage, the second refresh voltage corresponding to an inverted amplified voltage of the sensed pixel voltage;
a precharge unit configured to set the first and second terminals of the sense amp unit to a precharge voltage prior to sensing the pixel voltage on the data line; and
a switching unit configured to control the timing for connecting the data line and sense amp unit so that the pixel voltage on the data line is applied to the first terminal and a selected one of the first refresh voltage and the second refresh voltage is outputted to the data line.

13. The refresh circuit of claim 12, wherein the precharge unit is configured to set the first and second terminals to the precharge voltage while the sense amp unit is electrically disconnected from the data line.

14. The refresh circuit of claim 12, wherein the switching unit includes a first switch configured to control the timing for connecting the data line and the first terminal.

15. The refresh circuit of claim 14, wherein the first switch is turned ON to apply the pixel voltage on the data line to the first terminal precharged to the precharge voltage and to output the first refresh voltage of the first terminal to the data line.

16. The refresh circuit of claim 14, wherein the switching unit further includes a second switch configured to control the timing for connecting the data line and the second terminal.

17. The refresh circuit of claim 16, wherein the first switch is turned ON to apply the pixel voltage on the data line to the first terminal precharged to the precharge voltage and then the second switch is turned ON to output the second refresh voltage of the second terminal to the data line.

18. The refresh circuit of claim 12, wherein the switching unit includes at least one transmission gate coupled between the data line and the sense amp unit.

19. The refresh circuit of claim 12, wherein the sense amp unit comprises:
a first p-channel metal oxide semiconductor (PMOS) transistor coupled between a first power voltage and a first node, the first PMOS transistor having a gate to which an inverted signal of a sense amp control signal is applied;
a second PMOS transistor being coupled between the first node and the first terminal, the second PMOS transistor having a gate coupled to the second terminal;
a first n-channel metal oxide semiconductor (NMOS) transistor coupled between the first terminal and a second node, the first NMOS transistor having a gate coupled to the second terminal;
a third PMAS transistor coupled between the first node and the second terminal, the third PMOS transistor having a gate coupled to the first terminal;
a second NMOS transistor coupled between the second terminal and the to second nodes the second NMOS transistor having a gate coupled to the first terminal; and
a third NMOS transistor coupled between the second node and a second power voltage, the third NMOS transistor having a gate to which the sense amp control signal is applied.

20. The refresh circuit of claim 19, wherein the precharge voltage corresponds to an intermediate voltage between the first power voltage and the second power voltage.

21. A method of refreshing pixel voltages, the pixel voltages being respectively stored in a plurality of pixels included in a display panel, the pixels being coupled to a plurality of scan lines and to a plurality of data lines, the method comprising:
applying the pixel voltage to the data lines by selectively activating the scan lines;
sensing the pixel voltages on the data lines;
generating a first refresh voltage corresponding to an amplified voltage of the sensed pixel voltage and a second refresh voltage corresponding to an inverted-amplified voltage of the sensed pixel voltage, respectively; and
outputting one of the first refresh voltage and the second refresh voltage to each of the data lines to refresh the pixel voltage.

22. The method of claim 21, wherein sensing the pixel voltage comprises:
providing a precharge voltage for detecting a logic level of the pixel voltage; and
determining the logic level of the pixel voltage by detecting a difference between the pixel voltage applied to the data line and the precharge voltage.

23. The method of claim 22, wherein providing the precharge voltage is performed when the pixel voltage is applied to the data line or after the pixel voltage is applied to the data line.

24. The method of claim 21 wherein outputting one of the first refresh voltage to each of the data lines corresponds to outputting the first refresh voltage to the data line through a path identical to a path for sensing the pixel voltage on the data line.

25. The method of claim 21, wherein outputting one of the second refresh voltage to each of the data lines corresponds to outputting the second refresh voltage to the data line through a path different from a path for sensing the pixel voltage on the data line.

26. The method of claim 21 wherein all of the scan lines are sequentially activated, and all of the pixel voltages of the display panel are periodically refreshed.

27. The method of claim 21 wherein a portion of the scan lines are sequentially activated, and the pixel voltages corresponding to the activated portion of the scan lines are periodically refreshed.
